(19) United States
(12) Patent Application Publication
(10) Pub. No.: US 2021/0281189 A1
(43) Pub. Date: Sep. 9, 2021

(54) ACTIVE BRIDGE RECTIFIER

(71) Applicant: Navitas Semiconductor Limited, Dublin (IE)

(72) Inventors: Marco Giandalia, Marina Del Rey, CA (US); Daniel M. Kinzer, El Segundo, CA (US); Tao Liu, San Marino, CA (US)

(73) Assignee: Navitas Semiconductor Limited, Dublin (IE)

(21) Appl. No.: 17/191,451

(22) Filed: Mar. 3, 2021

Related U.S. Application Data
(60) Provisional application No. 62/984,767, filed on Mar. 3, 2020.

(51) Int. Cl. H02M 7/219; H02M 1/08

(52) U.S. Cl. CPC H02M 7/219; H02M 1/08

(57) ABSTRACT

A circuit is disclosed. The circuit includes first, second third and fourth diodes connected to form a bridge rectification circuit having a pair of input terminals to receive an AC input signal and a pair of output terminals to deliver a rectified DC signal. The circuit also includes a first semiconductor switch coupled in parallel with the first diode, a second semiconductor switch coupled in parallel with the second diode, and a switch control circuit coupled to the pair of input terminals and arranged to selectively operate the first and second semiconductor switches using power from the AC input signal at the pair of input terminals.

### CROSS REFERENCES TO RELATED APPLICATIONS

The present application claims the benefit of U.S. provisional application No. 62/984,767, filed Mar. 3, 2020, which is incorporated by reference in its entirety for all purposes.

### FIELD OF THE INVENTION

The present application generally pertains to bridge rectifier circuits, and more specifically to active bridge rectifier circuits.

### BACKGROUND OF THE INVENTION

Bridge rectifier circuits are used to generate substantially DC (direct current) signals based on an AC (alternating current) signal.

### BRIEF SUMMARY OF THE INVENTION

One inventive aspect is a circuit, including first, second third and fourth diodes connected to form a bridge rectification circuit having a pair of input terminals to receive an AC input signal and a pair of output terminals to deliver a rectified DC signal. The circuit also includes a first semiconductor switch coupled in parallel with the first diode, a second semiconductor switch coupled in parallel with the second diode, and a switch control circuit coupled to the pair of input terminals and arranged to selectively operate the first and second semiconductor switches using power from the AC input signal at the pair of input terminals.

In some embodiments, the first and second semiconductor switches are GaN-based transistors formed on a monolithic semiconductor die.

In some embodiments, the monolithic semiconductor die further includes a GaN-based first semiconductor switch driver circuit and a GaN-based second semiconductor switch driver circuit.

In some embodiments, one or more of the first, second, third, and fourth diodes, the first and second semiconductor switches, and at least a portion of the switch control circuit are formed on a first semiconductor substrate.

In some embodiments, one or more of the first, second, third, and fourth diodes, the first and second semiconductor switches, and at least a portion of the switch control circuit are formed on a second semiconductor substrate.

In some embodiments, the first and second substrates are co-packaged in an electronic package.

In some embodiments, the switch control circuit controls the second semiconductor switch to become conductive during a time when a first forward bias voltage is applied across the second diode, and the switch control circuit controls the first semiconductor switch to become conductive during a time when a second forward bias voltage is applied across the first diode.

Another inventive aspect is an electronic device including a monolithic GaN-based semiconductor substrate including a first semiconductor switch having a first pair of terminals arranged to be electrically coupled in parallel with a first external diode, a second semiconductor switch having a second pair of terminals arranged to be electrically coupled in parallel with a second external diode, and a switch control circuit coupled to at least one terminal of the first pair of terminals and coupled to at least one terminal of the second pair of terminals. The switch control circuit is arranged to selectively operate the first and second semiconductor switches using power from the at least one terminal of the first pair of terminals and the at least one terminal of the second pair of terminals.

In some embodiments, the first pair of terminals includes a first input terminal configured to be coupled to an AC input signal and a first output terminal configured to be coupled to an output node of a diode bridge, and the second pair of terminals includes a second input terminal configured to be coupled to the AC input signal and a second output terminal configured to be coupled to the output node of the diode bridge.

In some embodiments, the switch control circuit controls the first semiconductor switch to become conductive during a time when a first forward bias voltage is applied across the first external diode, and the switch control circuit controls the second semiconductor switch to become conductive during a time when a second forward bias voltage is applied across the second external diode.

In some embodiments, one or more of the first and second semiconductor switches, and at least a portion of the switch control circuit are formed on a first semiconductor substrate.

In some embodiments, one or more of the first and second semiconductor switches, and at least a portion of the switch control circuit are formed on a second semiconductor substrate.

In some embodiments, the first and second substrates are co-packaged in an electronic package.

In some embodiments, the electronic device also includes an electronic package formed around the monolithic GaN-based semiconductor substrate, the electronic package further formed around the first external diode and the second external diode.

Another inventive aspect is a rectifier circuit, including first and second input nodes configured to collectively receive an AC voltage, a ground node, and including an output node and first, second, third, and fourth conductive elements configured to provide a rectified voltage difference across the output node and the ground node based on the AC voltage input. The rectifier circuit also includes a switch control circuit configured to generate a plurality of switch signals, where the switch control circuit includes first and second power inputs respectively connected to the first and second input nodes, and where the AC voltage across the first and second input nodes causes the switch control circuit to generate the switch signals. The first conductive element includes a first switch, configured to selectively conduct in response to a first switch signal from the switch control circuit, and the second conductive element includes a second switch, configured to selectively conduct in response to a second switch signal from the switch control circuit.

In some embodiments, the first conductive element includes a first diode in parallel with the first switch, and the second conductive element includes a second diode in parallel with the second switch.

In some embodiments, there is no diode in parallel with any of the first and second switches.

In some embodiments, the switch control circuit includes a coupling portion configured to generate input signals, and the switch control circuit is configured to generate the switch signals in response to the input signals.

In some embodiments, the switch control circuit includes first and second driver portions configured to receive the input signals and to generate the switch signals in response to the input signals.

In some embodiments, the coupling portion is configured to receive the AC voltage across the first and second input nodes, and to generate the input signals by capacitively coupling the AC voltage to the first and second driver portions.

In some embodiments, the rectifier circuit also includes first and second clamps configured to clamp the input signals to a voltage based on a reference voltage.

In some embodiments, the rectifier circuit also includes third and fourth clamps configured to clamp the input signals to a DC or substantially DC voltage.

In some embodiments, the switch signals have voltages about equal to a reference voltage, whereby the switches receiving the switch signals are caused to become conductive.

In some embodiments, the switch signals have voltages greater than the maximum voltages of the first and second input nodes, whereby the switches receiving the switch signals are caused to become conductive.

In some embodiments, the switch signals have voltages less than the maximum voltages of the first and second input nodes, whereby the switches receiving the switch signals are caused to become conductive.

Another inventive aspect is a switch circuit, including a semiconductor substrate, including GaN, first and second input nodes formed on the substrate, and a switch control circuit formed on the substrate, where the switch control circuit includes first and second power inputs respectively connected to the first and second input nodes, and where the switch control circuit is configured to generate a plurality of switch signals in response to an AC voltage across the first and second input nodes. The switch circuit also includes a first switch formed on the substrate, where the first switch is connected to the first input node, and where the first switch is configured to selectively conduct in response to a first switch signal from the switch control circuit.

In some embodiments, the switch circuit also includes a second switch formed on the substrate, where the second switch is connected to the second input node, and where the second switch is configured to selectively conduct in response to a first switch signal from the switch control circuit.

In some embodiments, the switch circuit also includes first and second diodes, where the first diode is connected in parallel with the first switch, and where the second diode is connected in parallel with the second switch.

In some embodiments, the first and second diodes are packaged with the substrate in an electronic package.

In some embodiments, the switch circuit also includes third and fourth diodes, where the third diode is connected to the first switch and to the first diode, and where the second diode is connected to the second switch and to the second diode.

In some embodiments, the first, second, third, and fourth diodes are packaged with the substrate in an electronic package.

In some embodiments, the switch control circuit includes a coupling portion configured to generate input signals, where the switch control circuit is configured to generate the switch signals in response to the input signals, and first and second driver portions configured to receive the input signals and to generate the switch signals in response to the input signals.

In some embodiments, the coupling portion is configured to receive the AC voltage across the first and second input nodes, and to generate the input signals by capacitively coupling the AC voltage to the driver portions.

In some embodiments, the switch circuit also includes first and second clamps formed on the substrate, where the first and second clamps are configured to clamp the input signals to a voltage based on a reference voltage, and third and fourth clamps formed on the substrate, where the third and fourth clamps are configured to clamp the input signals to a DC or substantially DC voltage.

### BRIEF DESCRIPTION OF THE DRAWINGS

FIG. 1 is a schematic illustration of a conventional rectifier circuit.

FIGS. 2-4 illustrates waveforms showing the operation of the rectifier circuit of FIG. 1.

FIG. 5 is a schematic illustration of an embodiment of a rectifier circuit that includes four rectification diodes and active switches in parallel with two of the rectification diodes, according to embodiments of the disclosure.

FIG. 6 is a schematic illustration of an embodiment of a rectifier circuit that includes two rectification diodes and two active switches, according to embodiments of the disclosure.

FIG. 7 is a schematic illustration of an embodiment of a rectifier circuit that includes four rectification diodes and active switches in parallel with two of the rectification diodes, according to embodiments of the disclosure.

FIG. 8 is a schematic illustration of an embodiment of a rectifier circuit that includes two rectification diodes and two active switches, according to embodiments of the disclosure.

FIG. 9 is a schematic illustration of an embodiment of a rectifier circuit that includes four rectification diodes and active switches in parallel with each of the rectification diodes, according to embodiments of the disclosure.

FIG. 10 is a schematic illustration of an embodiment of a rectifier circuit that includes four active switches, according to embodiments of the disclosure.

FIG. 11 illustrates waveforms showing the operation of any of the rectifier circuits of FIG. 5, 7, or 9, according to embodiments of the disclosure.

FIG. 12 is a schematic illustration of the rectifier circuit illustrated in FIG. 5 including a schematic of one embodiment of the switch control circuit.

FIG. 13 illustrates waveforms showing the operation of the rectifier circuit of FIG. 12.

FIG. 14 is a schematic illustration of the rectifier circuit illustrated in FIG. 7 including a schematic of one embodiment of the switch control circuit.

FIG. 15 illustrates waveforms showing the operation of the rectifier circuit of FIG. 14, according to embodiments of the disclosure.

FIG. 16 is a schematic illustration of a packaging arrangement of a rectifier circuit, according to embodiments of the disclosure.

FIG. 17 is a schematic illustration of the rectifier circuit illustrated in FIG. 7 including a schematic of one embodiment of the switch control circuit.

FIG. 18 is a schematic illustration of the rectifier circuit illustrated in FIG. 7 including a schematic of one embodiment of the switch control circuit.

### DETAILED DESCRIPTION OF THE INVENTION

Particular embodiments of the invention are illustrated herein in conjunction with the drawings. Various details are set forth herein as they relate to certain embodiments. However, the invention can also be implemented in ways which are different from those described herein. Modifications can be made to the discussed embodiments by those skilled in the art without departing from the invention. Therefore, the invention is not limited to particular embodiments disclosed herein.

AC to DC converters and numerous other circuits generally have an input diode bridge rectifier which receives an AC power signal and generates a substantially DC power signal for the converter or other circuit based on the AC power signal. To perform the rectification, the diode bridge rectifier consumes power, and in many circuits the power consumed by the diode bridge rectifier can be a significant consideration. The active bridge rectifier circuits described herein use less power than conventional diode bridge rectifiers, can be driven directly from the AC power signal and can be implemented in a more cost and space efficient matter, as described in more detail below.

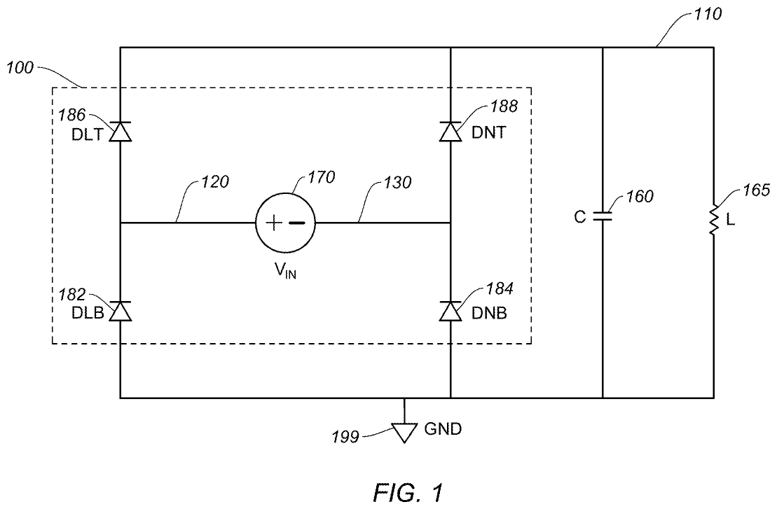

FIG. 1 is a schematic illustration of a rectifier circuit 100 configured to provide power to load 165 connected across output capacitor 160. Rectifier circuit 100 includes diodes DLB 182, DNB 184, DLT 186, and DNT 188, which form a diode bridge, as understood by those of skill in the art.

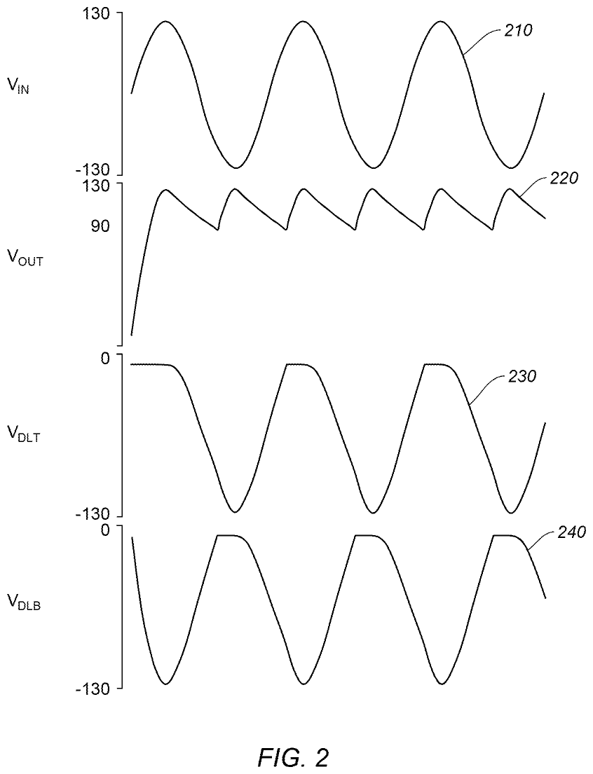

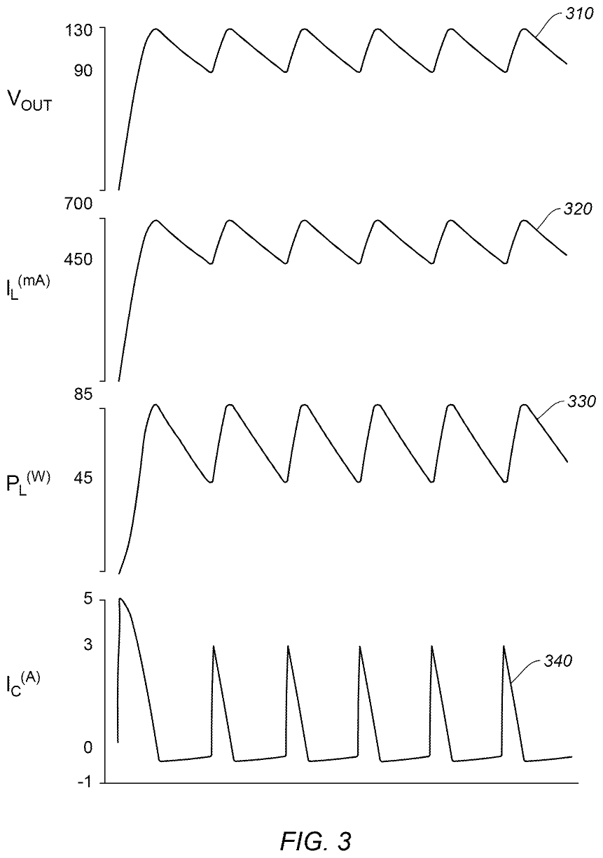

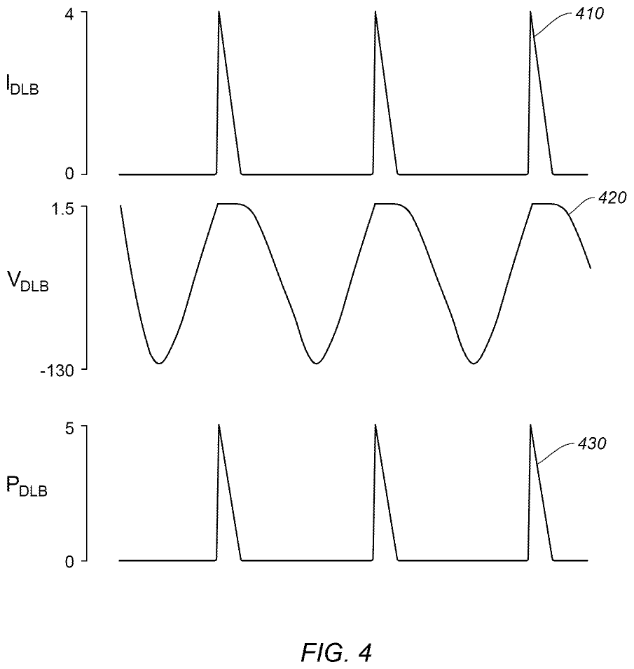

FIGS. 2-4 illustrate waveforms showing the operation of the rectifier circuit 100 of FIG. 1. An input voltage (Vin) is illustrated in example waveform 210, and can be any AC input voltage, for example from a standard AC line voltage. Waveform 210 is equal to the voltage at Positive node 120 of line input voltage 170 (Vin) minus the voltage at Negative node 130 of the line input voltage, and may, for example, oscillate between about +130 V and about −130 V. An output voltage (Vout) of rectifier circuit 100 at Vout node 110 is illustrated in example waveforms 220 and 310, and may, for example, have a ripple between about 130 V and about 90 V.

A voltage across diode DLT 186 (V_{DLT}) is illustrated by example waveform 230, and is the voltage at an anode of diode DLT 186 minus the voltage at a cathode of diode DLT 186. A voltage across diode DLB 182 (V_{DLB}) is illustrated by example waveforms 240 and 420, and is the voltage at an anode of diode DLB 182 minus the voltage at a cathode of diode DLB 182.

A current through load 165 (I_{L}) is illustrated in example waveform 320. A power delivered to load 165 (P_{L}) is illustrated by example waveform 330. A current delivered to capacitor 160 (I_{C}) is illustrated by example waveform 340. A forward bias current through diode DLB 182 (I_{DLB}) is illustrated by example waveform 410. A power consumed by diode DLB 182 (P_{DLB}) is illustrated by example waveform 430.

Diode DLT 186 becomes conductive when the voltage at Vin Positive node 120 is greater than the voltage at Vout node 110 by about one threshold voltage (Vt) of diode DLT 186. Similarly, diode DNT 188 becomes conductive when the voltage at Vin Negative node 130 is greater than the voltage at Vout node 110 by about one threshold voltage (Vt) of diode DNT 188.

Diode DLB 182 becomes conductive when the voltage at Vin Positive node 120 is less than a voltage at Ground node 199 by about one threshold voltage (Vt) of diode DLB 182.

Similarly, diode DNB 184 becomes conductive when the voltage at Vin Negative node 130 is less than a voltage at Ground node 199 by about one threshold voltage (Vt) of diode DNB 184.

As understood by those of skill in the art, because the threshold voltages of diodes DLB 182, DNB 184, DLT 186, and DNT 188 are non-zero, the rectifier circuit 100 of FIG. 1 has a power loss (e.g., inefficiency) that corresponds with the magnitudes of the threshold voltages of diodes DLB 182, DNB 184, DLT 186, and DNT 188. In some applications, the power loss caused by the threshold voltages of diodes DLB 182, DNB 184, DLT 186, and DNT 188 can be a relatively significant source of power loss in the rectifier circuit 100 of FIG. 1.

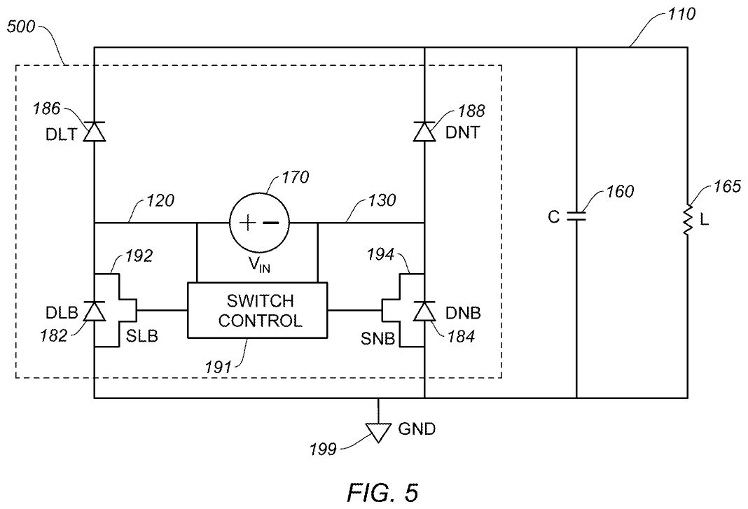

FIG. 5 is a schematic illustration of an embodiment of a rectifier circuit 500 that includes two shorting switches SLB 192 and SNB 194 in parallel with two diodes DLB 182 and DNB 184, respectively. As shown in FIG. 5, rectifier circuit 500 is configured to provide power to a load 165 connected across an output capacitor 160. The operation of shorting switches SLB 192 and SNB 194 are controlled by a switch control circuit 191.

More specifically, shorting switch 192 is controlled by switch control circuit 191 such that, during a time when the voltage at Vin Positive node 120 is less than ground voltage at ground node 199, shorting switch 192 is conductive, and during a time when the voltage at Vin Positive node 120 is greater than the ground voltage, shorting switch 192 is nonconductive. Similarly, shorting switch 194 is controlled by switch control circuit 191 such that, during a time when the voltage at Vin Negative node 130 is less than the ground voltage at ground node 199, shorting switch 194 is conductive, and during a time when the voltage at Vin Negative node 130 is greater than the ground voltage, shorting switch 194 is nonconductive.

Because the drain to source voltage Vds of shorting switches SLB 192 and SNB 194 during the time that they are conductive are non-zero, the rectifier circuit of FIG. 1 has losses which correspond with the magnitudes of the drain to source voltage Vds of shorting switches 192 and 194.

However, shorting switches SLB 192 and SNB 194 are sized such that their Vds voltages while conducting are less than the threshold voltages of diodes DLB 182 and DNB 184. Therefore, current from ground node 199 to the Vin Positive node 120 is conducted primarily or entirely by shorting switch SLB 192, and current from the ground node to the Vin Negative node 130 is conducted primarily or entirely by shorting switch SNB 194. Because the power loss of shorting switches SLB 192 and SNB 194 while conducting are less than the power loss of diodes DLB 182 and DNB 184, the rectifying circuit 500 of FIG. 5 has less loss than the rectifying circuit 100 of FIG. 1.

Diodes DLB 182 and DNB 184 may, for example, reduce power loss of rectifier circuit 500 by conducting current in parallel with shorting switches SLB 192 and SNB 194, for example, under surge current conditions and/or while shorting switches SLB and SNB are nonconductive.

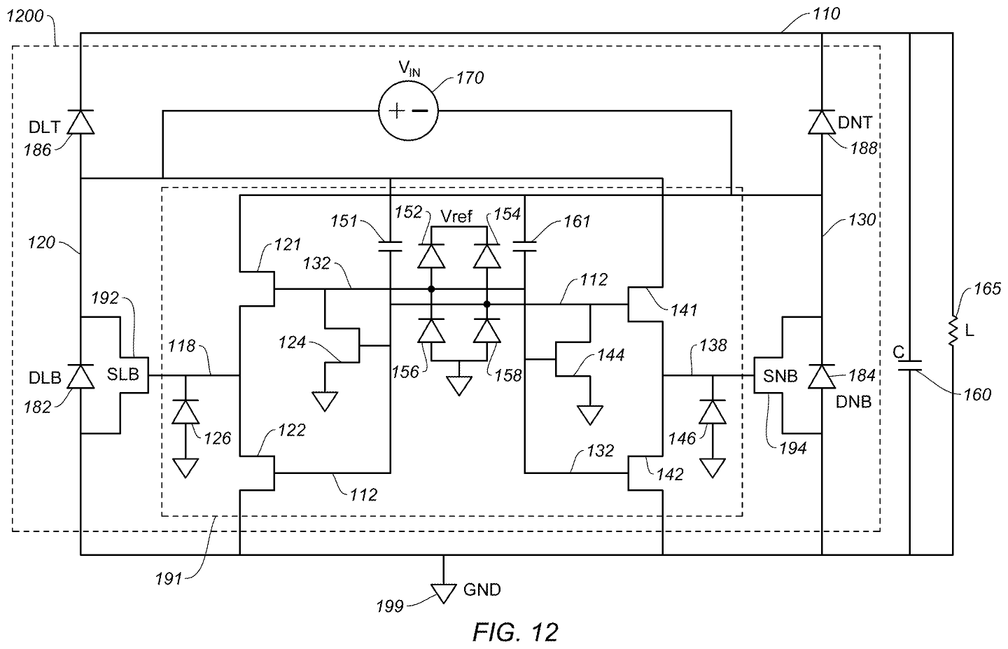

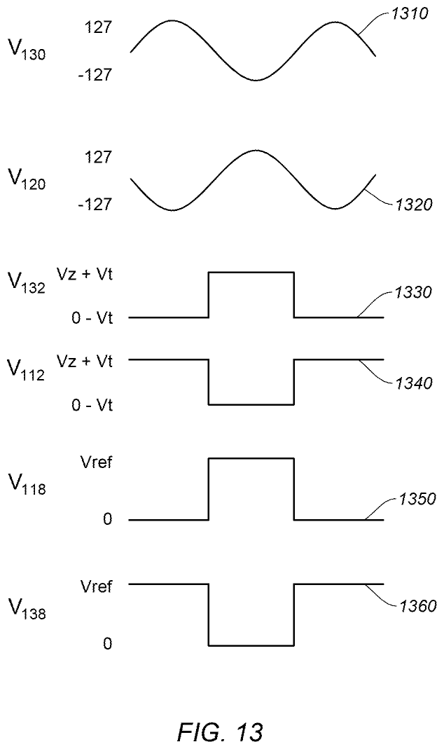

As shown in FIG. 5, in some embodiments switch control circuit 191 is driven by line input voltage 170, such that rectifier circuit 500 can be self-contained without the need for one or more external voltage sources. This configuration can make rectifier circuit 500 less costly and easier to implement than circuits that require one or more external voltage sources. In some embodiments switch control circuitry 191 comprises one or more of the following devices: GaN-based enhancement-mode transistors, GaN-based depletion-mode transistors, GaN-based depletion-mode transistors connected in series with silicon based enhancement-mode field-effect transistors having the gate of the depletion-mode transistor connected to the source of the silicon-based enhancement-mode transistor. An embodiment of control circuit 191 is described in greater detail below, specifically with reference to FIGS. 12 and 13.

In some embodiments, switch control circuit 191 includes driver and/or control circuitry for operating switches SLB 192 and SNB 194, as discussed in greater detail below, specifically with regard to FIGS. 12 and 13. In some embodiments switches SLB 192, SNB 194 and one or more components of switch control circuit 191 can be monolithically integrated on a single semiconductor die. In one embodiment the semiconductor die can be gallium nitride

(GaN) based where switches SLB 192, SNB 194 are formed as lateral transistors. In various embodiments a high level of integration can be enabled by the use of GaN-based lateral semiconductor switches because they do not require the substrate to be a power connection such as is typically required with silicon-based power MOSFET devices. This high-level of integration can enable reduced component count and overall system cost, as compared with systems that use discrete components. In some embodiments, for example, to reduce component count and to save system area and cost, some or all of the switch control circuit 191, switches SLB 192 and SNB 194 may be manufactured on a single monolithic GaN-based semiconductor die.

In various embodiments a first portion of the switch control circuit 191 may be disposed on a first GaN-based die and a second portion of the switch control circuit may be disposed on a second GaN-based die. In yet further embodiments, the switch control circuit 191, switches SLB 192 and SNB 194 may be disposed on more than two GaN-based devices. In one embodiment, the switch control circuit 191 may contain any number of active or passive circuit elements arranged in any configuration.

In further embodiments diodes DLB 182, DNB 184, DLT 186, and DNT 188 can be silicon-based diodes that are co-packaged with the one or more GaN-based die, or they can be one or more discrete devices in one or more separate electronic packages. In some embodiments, diodes DLB 182, DNB 184, DLT 186, and DNT 188 are formed with diode connected transistors. In various embodiments diodes DLB 182, DNB 184, DLT 186, and DNT 188 can be GaN-based diodes that are integrated with or co-packaged with one or more GaN-based die.

In some embodiments, the GaN-based die may have a substrate including a layer of GaN on a layer of silicon. In further embodiments the GaN-based substrate may include, but is not limited to, a layer of GaN on a layer of silicon carbide, sapphire or aluminum nitride. In some embodiments the GaN-based layer may include, but is not limited to, a composite stack of other III nitrides such as aluminum nitride and indium nitride and III nitride alloys such as AlGaN and InGaN.

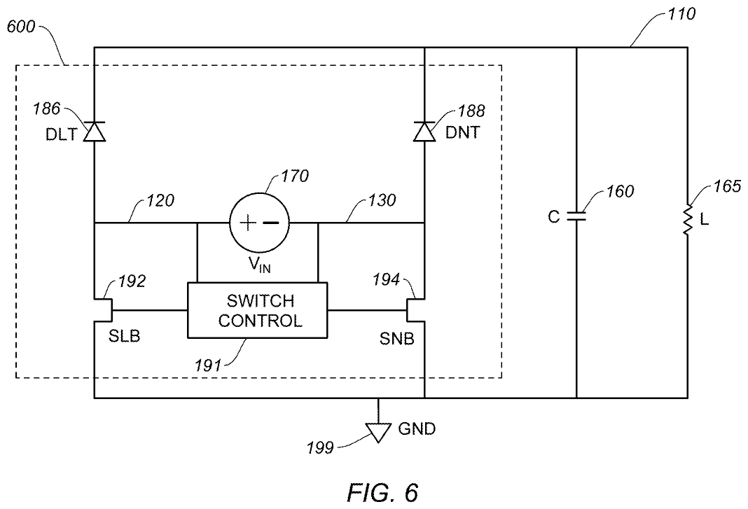

FIG. 6 is a schematic illustration of a rectifier circuit 600 that is similar to the rectifier circuit 500 shown in FIG. 5, however rectifier circuit 600 does not have diodes DLB 182 and

DNB 184 of rectifier circuit 500. Thus, switches SLB 192 and SNB 194 must operate for rectifier circuit 600 to function and should be sized to accommodate any overload or surge conditions. As shown in FIG. 6, rectifier circuit 600 is configured to provide power to load 165 connected across output capacitor 160. The rectifier circuit 600 includes shorting switches SLB 192 and SNB 194, which are controlled by a switch control circuit 191.

More specifically, shorting switch SLB 192 is controlled by switch control circuit 191 such that, during a time when the voltage at Vin Positive node 120 is less than ground voltage at ground node 199, shorting switch SLB 192 is conductive, and during a time when the voltage at Vin Positive node 120 is greater than the ground voltage, shorting switch SLB 192 is nonconductive. Similarly, shorting switch SNB 194 is controlled by switch control circuit 191 such that, during a time when the voltage at Vin Negative node 130 is less than the ground voltage at ground node 199, shorting switch SNB 194 is conductive, and during a time when the voltage at Vin Negative node 130 is greater than the ground voltage, shorting switch SNB 194 is nonconductive.

As described above, shorting switches SLB 192 and SNB 194 are sized such that their power loss is less than the diodes DLB 182 and DNB 184 of FIG. 1. Therefore, the rectifying circuit 600 of FIG. 6 has less power loss than the rectifying circuit 100 of FIG. 1.

In some embodiments, for example, where separate silicon-based diodes are used, the removal of diodes DLB and DNB (see FIG. 5) can reduce cost and size of rectifier circuit 600 as compared to rectifier circuit 500, especially in the case where switch control circuit 191 and switches SLB 192 and SNB 194 are integrated on a single monolithic GaN-based die.

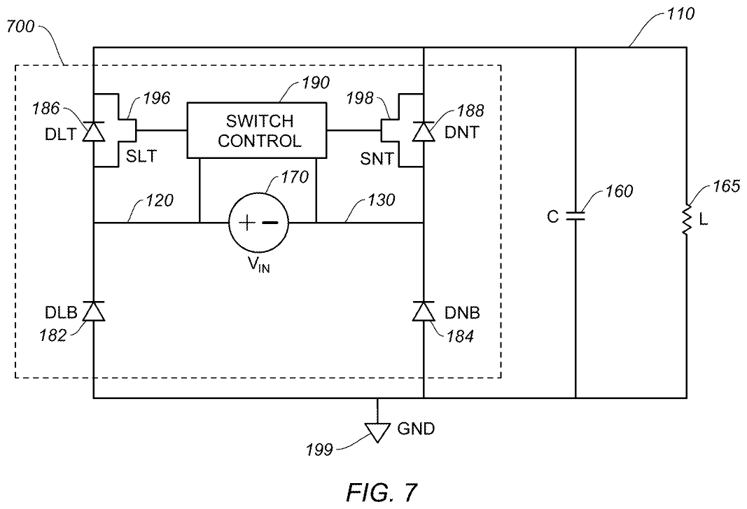

FIG. 7 is a schematic illustration of an embodiment of a rectifier circuit 700 that is similar to the rectifier circuit 500 shown in FIG. 5, however rectifier circuit 700 includes switches SLT 196 and SNT 198 in parallel with diodes DLT 186 and DNT 188, respectively. As shown in FIG. 7, shorting switch SLT 196 is controlled by switch control circuit 190 such that, during a time when the voltage at Vin Positive node 120 is greater than the voltage at Vout node 110, shorting switch SLT 196 is conductive, and during a time when the voltage at Vin Positive node 120 is less than the voltage at Vout node 110, shorting switch SLT 196 is nonconductive. Similarly, shorting switch SNT 198 is controlled by switch control circuit 190 such that, during a time when the voltage at Vin Negative node 130 is greater than the voltage at Vout node 110, shorting switch SNT 198 is conductive, and during a time when the voltage at Vin Negative node 130 is less than the voltage at Vout node 110, shorting switch SLT 196 is nonconductive.

Shorting switches SLT 196 and SNT 198 are sized such that their Vds voltages while conducting are less than the threshold voltages of diodes DLT 186 and DNT 188. Therefore, current from the Vin Positive node 120 to the Vout node 110 is conducted primarily or entirely by shorting switch SLT 196, and current from the Vin Negative node 130 to the Vout node 110 is conducted primarily or entirely by shorting switch 198. Because the power loss of shorting switches SLT 196 and SNT 198 while conducting are less than the power loss of diodes DLT 186 and DNT 188, the rectifying circuit 700 of FIG. 7 has less loss than the rectifying circuit 100 of FIG. 1.

Diodes DLT 186 and DNT 188 may, for example, reduce power loss of rectifier circuit 700 by conducting current in parallel with shorting switches SLT 196 and SNT 198, for example, under surge current conditions and/or while shorting switches SLT and SNT are nonconductive.

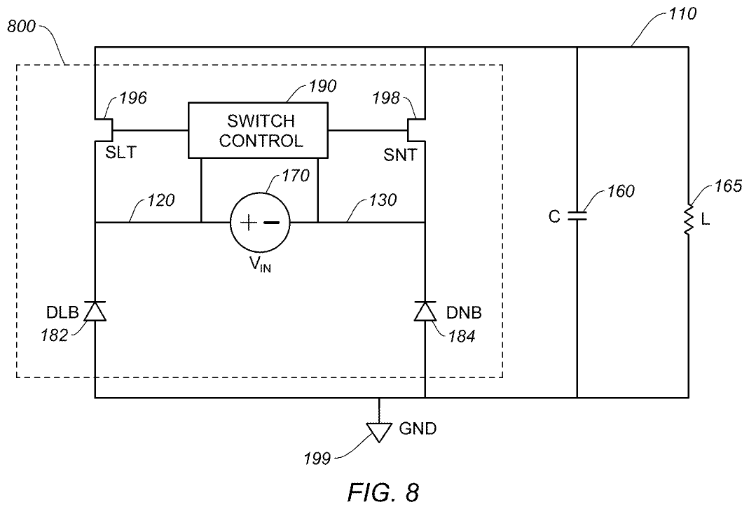

FIG. 8 is a schematic illustration of a rectifier circuit 800 that is similar to the rectifier circuit 500 shown in FIG. 5, however rectifier circuit 800 does not have diodes DLT 186 and DNT 188 of rectifier circuit 500. Thus, switches SLT 196 and SNT 198 must operate for rectifier circuit 800 to function and should be sized to accommodate any overload or surge conditions. As shown in FIG. 8, rectifier circuit 800 is configured to provide power to load 165 connected across output capacitor 160. The rectifier circuit 800 includes shorting switches SLT 196 and SNT 198, which are controlled by switch control circuit 190. Switch control circuit 190 may be similar to switch control circuit 191 and may be integrated on one or more monolithic GaN devices as described above.

Shorting switch SLT 196 is controlled by switch control circuit 190 such that, during a time when the voltage at Vin Positive node 120 is greater than the voltage at Vout node 110, shorting switch SLT 196 is conductive, and during a time when the voltage at Vin Positive node 120 is less than the voltage at Vout node 110, shorting switch SLT 196 is nonconductive. Similarly, shorting switch SNT 198 is controlled by switch control circuit 190 such that, during a time when the voltage at Vin Negative node 130 is greater than the voltage at Vout node 110, shorting switch SNT 198 is conductive, and during a time when the voltage at Vin Negative node 130 is less than the voltage at Vout node 110, shorting switch SNT 198 is nonconductive.

As described above, shorting switches SLT 196 and SNT 198 are sized such that their power loss is less than the diodes DLT 186 and DNT 188 of FIG. 1. Therefore, the rectifying circuit 800 of FIG. 8 has less power loss than the rectifying circuit 100 of FIG. 1.

In some embodiments, for example, where separate silicon-based diodes are used, the removal of diodes DLT and DNT (see FIG. 5) can reduce cost and size of rectifier circuit 800 as compared to rectifier circuit 500, especially in the case where switch control circuit 190 and switches SLT 196 and SNT 198 are integrated on a single monolithic GaN-based die.

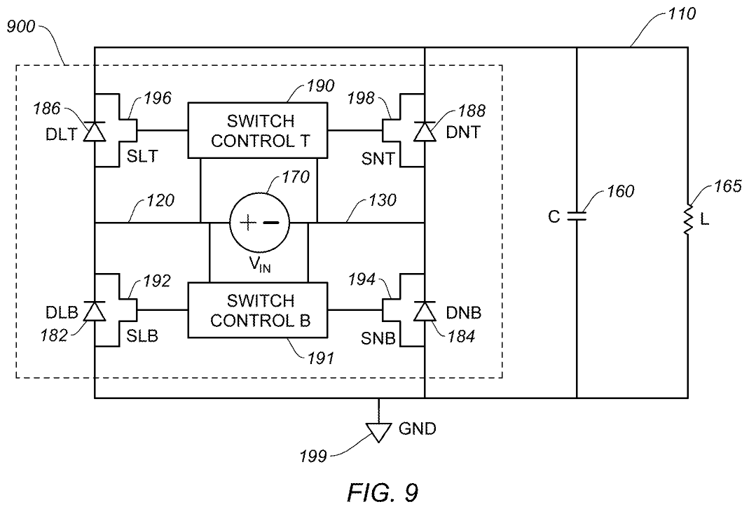

FIG. 9 is a schematic illustration of an embodiment of a rectifier circuit 900 that is similar to the rectifier circuit 500 shown in FIG. 5, however rectifier circuit 900 includes a second switch control circuit 190 arranged to control switch SLT 196 in parallel with diode DLT 186 and switch SNT 198 in parallel with diode DNT 188. As shown in FIG. 9, rectifier circuit 900 is configured to provide power to load 165 connected across output capacitor 160.

Shorting switch SLB 192 is controlled by switch control circuit 191 such that, during a time when the voltage at Vin Positive node 120 is less than a voltage at Ground node 199, shorting switch SLB 192 is conductive, and during a time when the voltage at Vin Positive node 120 is greater than a voltage at Ground node 199, shorting switch SLB 192 is nonconductive. Similarly, shorting switch SNB 194 is controlled by switch control circuit 191 such that, during a time when the voltage at Vin Negative node 130 is less than the a voltage at Ground node 199, shorting switch SNB 194 is conductive, and during a time when the voltage at Vin Negative node 130 is greater than the a voltage at Ground node 199, shorting switch SNB 194 is nonconductive.

Shorting switch SLT 196 is controlled by switch control circuit 190 such that, during a time when the voltage at Vin Positive node 120 is greater than the voltage at Vout node 110, shorting switch SLT 196 is conductive, and during a time when the voltage at Vin Positive node 120 is less than the voltage at Vout node 110, shorting switch SLT 196 is nonconductive. Similarly, shorting switch SNT 198 is controlled by switch control circuit 190 such that, during a time when the voltage at Vin Negative node 130 is greater than the voltage at Vout node 110, shorting switch SNT 198 is conductive, and during a time when the voltage at Vin Negative node 130 is less than the voltage at Vout node 110, shorting switch SNT 198 is nonconductive.

As described above, shorting switches SLT 196, SNT 198, SLB 192 and SNB 194 are sized such that their Vds voltages while conducting are less than the threshold voltages of respective diodes DLT 186, DNT 188, DLB 182 and DNB 184, therefore, the rectifying circuit 900 of FIG. 9 has less loss than the rectifying circuit 100 of FIG. 1.

Diodes DLT 186, DNT 188, DLB 182 and DNB 184 may, for example, reduce power loss of rectifier circuit 900 by conducting current in parallel with shorting switches SLT 196, SNT 198, SLB 192 and SNB 194, for example, under surge current conditions and/or while shorting switches SLT 196, SNT 198, SLB 192 and SNB 194 are nonconductive. As further described above, any of switches SLT 196, SNT 198, SLB 192 and SNB 194, switch controller 190 and switch controller 191 can be integrated on one or more GaN-based monolithic semiconductor die.

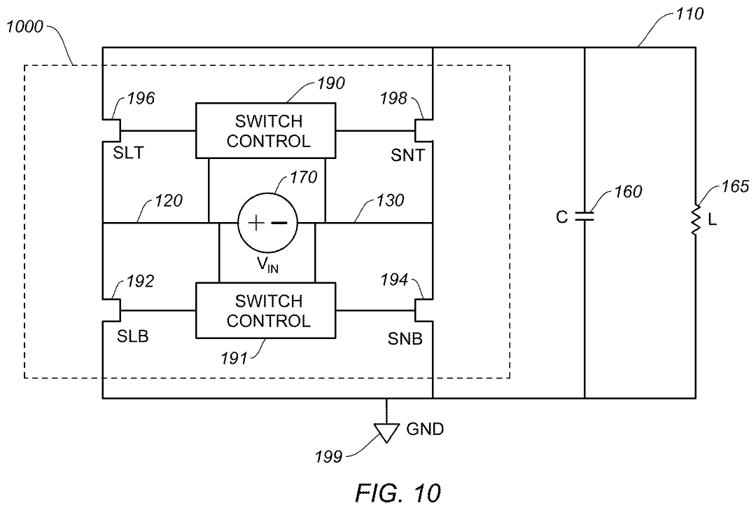

FIG. 10 is a schematic illustration of a rectifier circuit 1000 that is similar to the rectifier circuit 900 shown in FIG. 9, however rectifier circuit 1000 does not have diodes DLT 186, DNT 188, DLB 182 or DNB 184 of rectifier circuit 900. Thus, switches SLT 196, SNT 198, SLB 192 and SNB 194 must operate for rectifier circuit 1000 to function and should be sized to accommodate any overload or surge conditions. As shown in FIG. 10, rectifier circuit 1000 is configured to provide power to load 165 connected across output capacitor 160. The rectifier circuit 1000 includes shorting switches SLT 196 and SNT 198, which are controlled by switch control circuit 190 and shorting switches SLB 192 and SNB 194, which are controlled by switch control circuit 191. Switch control circuit 190 and 191 and may be integrated on one or more monolithic GaN devices along with switches SLT 196, SNT 198, SLB 192 and SNB 194 as described above.

The operation of switch control circuits 190 and 191 are described in more detail herein. As further described above, shorting switches SLT 196, SNT 198, SLB 192 and SNB 194 are sized such that their power loss is less than the diodes DLT 186, DNT 188, DLB 182 or DNB 184 of FIG. 1 such that rectifying circuit 1000 has less power loss than the rectifying circuit 100 of FIG. 1.

In some embodiments, for example, where separate silicon-based diodes are used, the removal of diodes DLT 186, DNT 188, DLB 182 and DNB 184 (see FIG. 5) can reduce cost and size of rectifier circuit 1000 as compared to rectifier circuit 500, especially in the case where switch control circuits 190, 191 and switches SLT 196, SNT 198, SLB 192 and SNB 194 are integrated on a single monolithic GaN-based die. As further described above, any of switches SLT 196, SNT 198, SLB 192 and SNB 194, switch controller 190 and switch controller 191 can be integrated on one or more GaN-based monolithic semiconductor die.

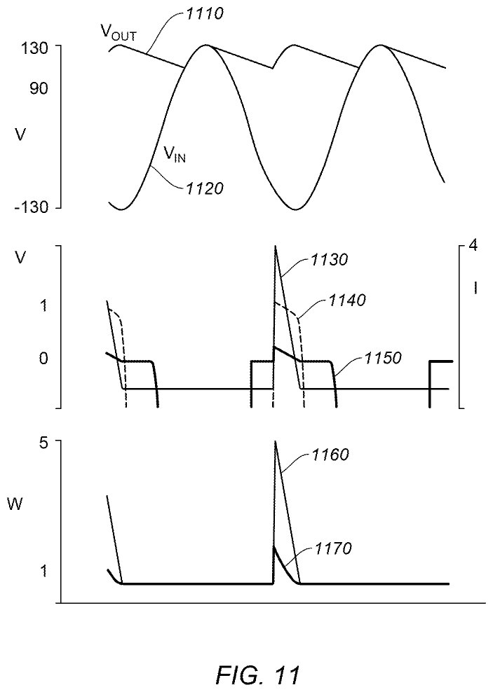

FIG. 11 illustrates waveforms showing the operation of the rectifier circuits of any of FIGS. 5-10. As shown in FIG. 11, input voltage 170 (Vin) is illustrated in example waveform 1120, and is equal to the voltage at Vin Positive node 120 minus the voltage at Vin Negative node 130 for the rectifier circuits any of FIGS. 5-10. As shown, Vin oscillates between about +130 V and about −130 V. Other input voltage ranges may be used.

Output voltage at Vout node 110 is illustrated in example waveform 1110. As shown, Vout has a ripple, for example, between about 130 V and about 90 V. Waveform 1130 shows the current through any of the four branches of FIGS. 5-10: (1) from the ground node to the Vin Positive node 120, (2) from the ground node to the Vin Negative node 130, (3) from the Vin Positive node 120 to the Vout node 110 and (4) from the Vin Negative node 130 to the Vout node 110. In branches in embodiments that do not have a switch shorting out the diode, the current 1130 is conducted by the diode. In the current branches that do have a switch that shorts out the diode, the current 130 is conducted entirely or almost entirely by the shorting switch. In the branches without diodes, the current of current waveform 1130 is conducted by the shorting switch.

Waveform 1140 illustrates the voltage across any of the four branches of FIGS. 5-10: (1) from the ground node 199 to the Vin Positive node 120, (2) from the ground node 199 to the Vin Negative node 130, (3) from the Vin Positive node 120 to the Vout node 110 and (4) from the Vin Negative node 130 to the Vout node 110, while operating with a diode and without a shorting switch shorting the diode.

Waveform 1150 illustrates the voltage across any of the four branches of FIGS. 5-10: (1) from the Vout node 110 to the Vin Positive node 120, (2) from the Vout node 110 to the Vin Negative node 130, (3) from the Vin Positive node 120 to the Vout node 110 and (4) from the Vin Negative node 130 to the Vout node 110, while operating with either a shorting switch shorting a diode, or a shorting switch without a diode.

As shown in FIG. 11, the voltage of waveform 1150, while operating with either a shorting switch shorting a diode, or a shorting switch without a diode, is significantly less than the voltage of voltage waveform 1140, while operating with a diode and without a shorting switch shorting the diode.

Waveform 1160 illustrates the power consumed by the branches described above. More specifically, waveform 1170 illustrates the power consumed by a branch while operating with either a shorting switch shorting a diode, or a shorting switch without a diode. As shown in FIG. 11, the power consumed by a branch while operating with either a shorting switch shorting a diode or a shorting switch without a diode, is significantly less than the power consumed in a branch while operating with a diode and without a shorting switch shorting the diode.

In the illustration of the waveforms of FIG. 11, the illustrated branch current, voltages, and powers have nonzero values generally aligned with minimum values of the input voltage

Vin. As understood by those of skill in the art, some branch currents, voltages, and powers have nonzero values generally aligned with maximum values of the input voltage Vin.

FIG. 12 is a schematic illustration of the rectifier circuit illustrated in FIG. 5 including a more detailed schematic of one embodiment of the switch control circuit 191. Switch control circuit 191 is also used in FIGS. 6, 9 and 10 with like numbers referring to like elements.

The switch control circuit 191 of FIG. 12 has power connections and signal input connections to the Vin Positive node 120 and Vin Negative node 130, such that it does not require any external voltage sources to operate.

The switch control circuit of FIG. 12 includes pull up switches 121 and 141, pull down switches 122 and 142, off switches 124 and 144, voltage clamps 152, 154, 156, 158, 126, and 146, and input capacitors 151 and 161. In some embodiments, switches 121, 141, 192, and 194 have higher breakdown voltages than breakdown voltages of, for example, one or more of switches 124, 144, 122, and 142. For example, in some embodiments, switches 121, 141, 192, and 194 can tolerate drain to source, gate to drain, and gate to source voltages up to about 650 V.

In some embodiments, switches 124, 144, 122, and 142 can tolerate drain to source, gate to drain, and gate to source voltages up to about 6.5 V.

The switch control circuit 191 of FIG. 12 includes an input coupling portion, comprising input capacitors 151 and 161. The switch control circuit 191 of FIG. 12 also includes first and second driver portions. The first driver portion comprises pull up switch 121, pull down switch 122, off switch 124, and voltage clamp 126. The second driver portion comprises pull up switch 141, pull down switch 142, off switch 144, and voltage clamp 146.

The first driver portion receives first input signals from the input coupling portion, and receives a power input from the node Neutral. Based on the first input signals, the first driver portion selectively causes the shorting switch 192 to be selectively conductive using current received from the power input from the node Neutral.

The second driver portion receives second input signals from the input coupling portion, and receives a power input from the node Line. Based on the second input signals, the second driver portion selectively causes the shorting switch 194 to be selectively conductive using current received from the power input from the node Line.

FIG. 13 illustrates waveform diagrams showing the operation of the rectifier circuit 1200 of FIG. 12. As shown in FIG. 13, In response to the input voltage Vin causing the voltage at node Line V_{L} to go high and the voltage at node Neutral V_{N} to go low, the signal input connection at input capacitor CL causes the voltage V₁₁₂ (voltage at node 112) to go high, and the signal input connection at input capacitor 161 causes the voltage V₁₃₂ (voltage at node 132) to go low. Clamps 152, 154, 156, and 158 respectively clamp the high and low voltages of nodes 112 and 132 to the reference voltage at input node Vref (reference voltage) plus a clamp threshold voltage and the ground voltage minus a clamp threshold voltage.

In some embodiments the reference voltage may be generated by an integrated reference voltage source or can be generated externally, for example, using a reference generator. In some embodiments a Zener reference diode can be used, for example, having its anode connected to the ground voltage. In some embodiments, the reference voltage may be generated on the same semiconductor die as the clamps 152, 154, 156, and 158. For example, the reference voltage may be generated by a number of serially connected diodes configured to conduct current from the Vref node to the ground node.

In some embodiments, the reference voltage at input node Vref is generated based on a current. In some embodiments, the current is provided to the reference generator by an external current source. In some embodiments, the current is provided to the reference generator by clamps 152 and 154.

The voltage V₁₁₂ at node 112 going high turns on switch 141, such that current from the power connection to node 130 causes the voltage V₁₃₈ at the gate node 138 of switch 194 to go high such that switch 194 becomes conductive, and shorts out diode 184.

The voltage V₁₃₈ at the gate node 138 of switch 194 is one threshold voltage less than the voltage V₁₁₂ at node 112. Therefore, because the voltage V₁₁₂ at node 112 is clamped to the reference voltage plus a clamp threshold, the voltage V₁₃₈ at the gate node 138 of switch 194 is about equal to the reference voltage. The voltage V₁₁₂ at node 112 going high also turns on switch 124, such that switch 121 is nonconductive. The voltage V₁₁₂ at node 112 going high also turns on switch 122, such that switch 122 conducts charge from the gate node 118 of switch 192 to the power connection at the source of switch 192, and the voltage V₁₁₈ at the gate node 118 of switch 192 goes low causing switch 192 to become nonconductive.

The voltage V₁₁₂ at node 112 going low turns off switch 141, such that switch 142 turning on causes the voltage V₁₃₈ at the gate node 138 of switch 194 to go low and switch 194 becomes nonconductive. The voltage V₁₁₂ at node 112 going low also turns off switches 124 and 122, such that the voltages V₁₃₂ and V₁₁₈ at nodes 132 and 118 can go high, so that switches 121 and 192 can be turned on.

In response to the input voltage across Vin Negative node 120 and Vin Positive node 130 causing the voltage V₁₂₀ at node 120 to go low and the voltage V₁₃₀ at node 130 to go high, the signal input connection at input capacitor 151 causes the voltage V₁₁₂ at node 112 to go low, and the signal input connection at input capacitor 161 causes the voltage V₁₃₂ at node 132 to go high. Clamps 152, 154, 156, and 158 respectively clamp the high and low voltages of nodes 112 and 132 to the reference voltage at input node Vref plus a clamp threshold voltage and the ground voltage minus a clamp threshold voltage.

The voltage V₁₃₂ at node 132 going high turns on switch 121, such that current from the power connection to node 130 causes the voltage V₁₁₈ at the gate node 118 of 192 to go high such that switch 192 becomes conductive, and shorts out diode 182.

As understood by those of skill in the art, the voltage V₁₁₈ at the gate node 118 of switch 192 is one threshold voltage less than the voltage V₁₃₂ at node 132. Therefore, because the voltage V₁₃₂ at node 132 is clamped to the reference voltage plus a clamp threshold, the voltage V₁₁₈ at the gate node 118 of switch 192 is about equal to the reference voltage, as understood by those of skill in the art.

The voltage V₁₃₂ at node 132 going high also turns on switch 144, such that switch 140 is nonconductive. The voltage V₁₃₂ at node 132 going high also turns on switch 142, such that switch 142 conducts charge from the gate node 138 of switch 194 to the power connection at the source of switch 194, and the voltage V₁₃₈ at the gate node 138 of switch 194 goes low causing switch 194 to become nonconductive.

The voltage V₁₃₂ at node 132 going low turns off switch 121, such that switch 122 turning on causes the voltage V₁₁₈ at the gate node 118 of switch 118 to go low and switch 118 becomes nonconductive. The voltage at node V₁₃₂ going low also turns off switches 144 and 142, such that the voltages V₁₁₂ and V₁₃₈ at nodes 112 and 138 can go high, so that switches 141 194 can be turned on. Clamp 126 clamps the voltage V₁₁₈ of node 118 to the ground voltage minus a clamp threshold voltage. Clamp 146 clamps the voltage V₁₃₈ of node 138 to the ground voltage minus a clamp threshold voltage.

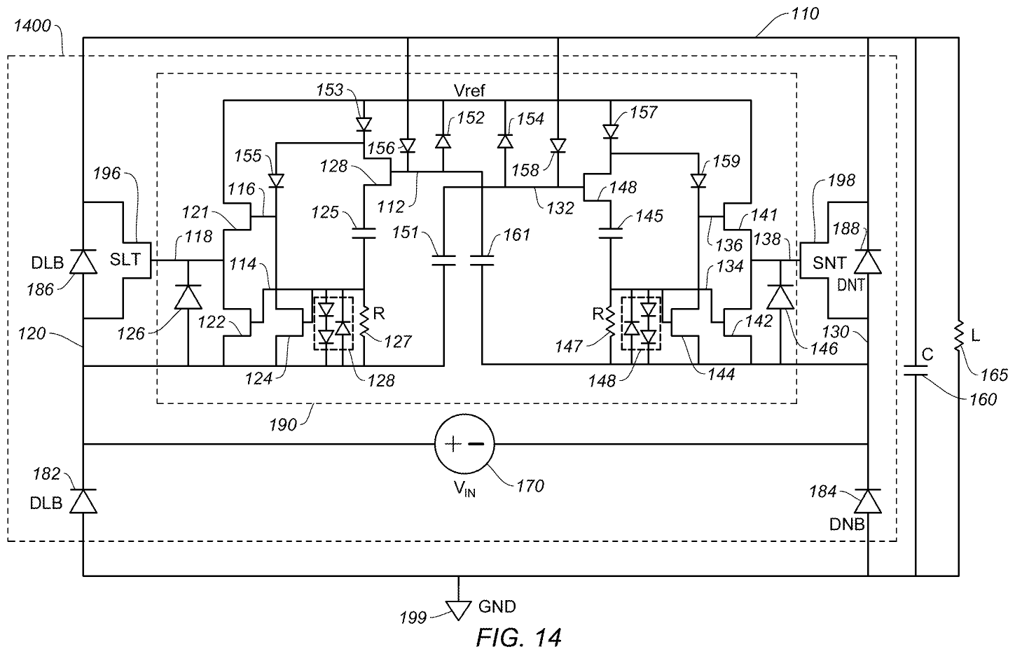

FIG. 14 is a schematic illustration of the rectifier circuit illustrated in FIG. 7 including a more detailed schematic of one embodiment of the switch control circuit 190. As shown in FIG. 14, the control and driver elements of one embodiment of switch control circuit 190 are shown. Switch control circuit 190 is also used in FIGS. 8, 9 and 10 with like numbers referring to like elements.

The switch control circuit 190 of FIG. 14 has power connections and signal input connections to the Vin Positive node 120 and Vin Negative node 130, such that it does not require any external voltage sources to operate.

The rectifier circuit 1400 includes diodes 182, 184, 186, and 188, and shorting switches 196 and 198. The switch control circuit 190 of FIG. 14 has power connections to the nodes 120 and 130, as illustrated. In addition, the switch control circuit 190 of FIG. 14 has signal input connections to the nodes 120 and 130.

The switch control circuit 190 of FIG. 14 includes pull up switches 121 and 141, pull down switches 122 and 142, off switches 124 and 144, diodes 153, 155, 157, and 159, level shift switches 128 and 148, level shift capacitors 125 and 145, level shift resistors 127 and 147, level shift clamps 128 and 148, voltage clamps 152, 154, 156, 158, 126, and 146, and capacitors 151 and 161.

In some embodiments, switches 121, 141, 196, and 198 have higher breakdown voltages than breakdown voltages of, for example, one or more of switches 128, 148, 124, 144, 122, and 142. For example, in some embodiments, switches 121, 141, 196, and 198 can tolerate drain to source, gate to drain, and gate to source voltages up to about 650 V. In some embodiments, switches 128, 148, 124, 144, 122, and 142 can tolerate drain to source, gate to drain, and gate to source voltages up to about 6.5 V.

In some embodiments, diodes 155 and 159 have higher breakdown voltages than breakdown voltages of, for example, one or more of diodes 153 and 157. For example, in some embodiments, diodes 155 and 159 can tolerate anode/cathode voltage differences up to about 650 V. In some embodiments, diodes 153 and 157 can tolerate anode/cathode voltage differences up to about 6.5 V.

The switch control circuit 190 of FIG. 14 includes an input coupling portion, comprising input capacitors 151 and 161. The switch control circuit 190 of FIG. 14 also includes first and second driver portions. The first driver portion comprises pull up switch 121, pull down switch 122, off switch 124, diodes 153 and 155, level shift switch 124, level shift capacitor 125, level shift resistor 127, level shift clamp 128, and voltage clamp 126. The second driver portion comprises pull up switch 141, pull down switch 142, off switch 144, diodes 157 and 159, level shift switch 148, level shift capacitor 145, level shift resistor 147, level shift clamp 148, and voltage clamp 146.

The first driver portion receives first input signals from capacitor 161 of the input coupling portion, and receives a power input from the node 120. Based on the first input signals, the first driver portion selectively causes the shorting switch 196 to be selectively conductive using current conducted from the voltage reference input node Vref and current conducted to the power input from the node 120.

The second driver portion receives second input signals from capacitor 151 of the input coupling portion, and receives a power input from the node 130. Based on the second input signals, the second driver portion selectively causes the shorting switch 198 to be selectively conductive using current conducted from the voltage reference input node Vref and current conducted to the power input from the node 130.

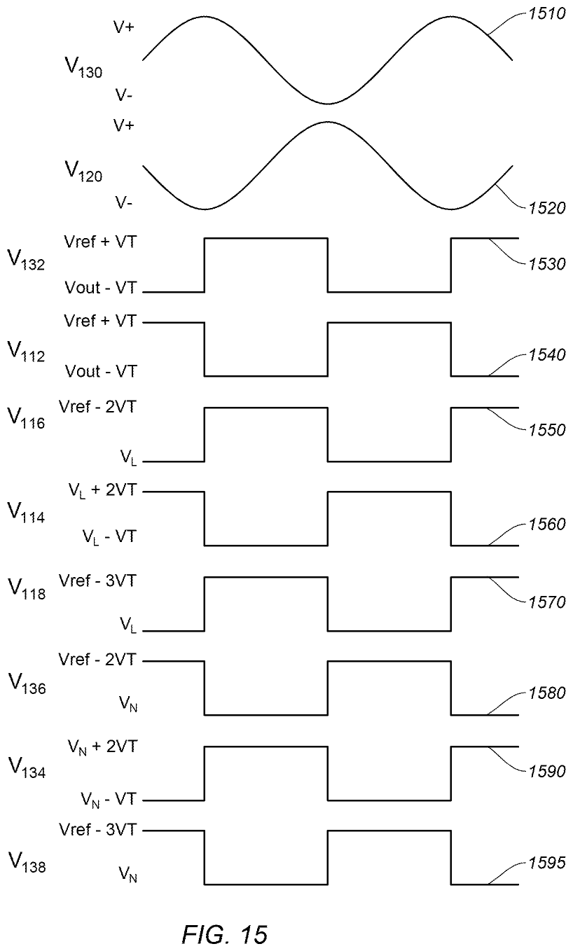

FIG. 15 illustrates waveforms showing the operation of the rectifier circuit 1400 of FIG. 14, according to embodiments of the disclosure. In response to the input voltage across nodes 120 and 130 causing the voltage V₁₂₀ at node 120 to go high and the voltage V₁₃₀ at node 130 to go low, the signal input connection at input capacitor 151 causes the voltage V₁₃₂ at node 132 to go high, and the signal input connection at input capacitor 161 causes the voltage V₁₁₂ at node 112 to go low. Clamps 152, 154, 156, and 158 respectively clamp the high and low voltages of nodes 112 and 132 to the reference voltage at input node Vref plus a clamp threshold voltage and the voltage at node 110 minus a clamp threshold voltage.

In some embodiments the reference voltage may be generated by an integrated reference voltage source formed on the same monolithic die as the other driver and control components or can be generated externally, for example, using a reference generator. The reference voltage may be generated externally, for example, using a reference generator, for example, including a Zener reference diode, for example, having its anode connected to the node 110.

In some embodiments, the reference voltage at input node Vref is generated based on a current. In some embodiments, the current is provided to the reference generator by an external current source. In some embodiments, the current is provided to the reference generator by clamps 152 and 154.

The voltage V₁₁₂ at node 112 going low turns off level shift switch 128, such that level shift resistor 127 conducts current from node 114 and causes the voltage V₁₁₄ at node 114 to go low such that switches 124 and 122 become nonconductive. Switch 124 becoming nonconductive allows current from node Vref through diodes 153 and 155 to cause the voltage V₁₁₆ at node 116 to go high. The voltage V₁₁₆ at node 116 being high turns on switch 121.

In response to switch 121 being conductive and switch 122 being nonconductive, current from node Vref through switch 121 causes the voltage V₁₁₈ at node 118 to become high, causing switch 196 to become conductive.

The voltage V₁₃₂ at node 132 going high turns on level shift switch 148, such that current from node Vref causes level shift capacitor 145 to increase the voltage V₁₃₄ at node 134 to go high such that switches 144 and 142 become conductive.

Switch 144 becoming conductive causes the voltage V₁₃₆ at node 136 to go low, such that switch 141 becomes nonconductive. In response to switch 141 being nonconductive and switch 142 being conductive, switch 142 causes the voltage V₁₃₈ at node 138 to become low, causing switch 198 to become nonconductive.

In response to the input voltage across nodes 120 and 130 causing the voltage V₁₂₀ at node 120 to go low and the voltage V₁₃₀ at node 130 to go high, the signal input connection at input capacitor 151 causes the voltage V₁₃₂ at node 132 to go low, and the signal input connection at input capacitor 161 causes the voltage V₁₁₂ at node 112 to go high. Clamps 152, 154, 156, and 158 respectively clamp the high and low voltages of nodes 112 and 132 to the reference voltage at input node Vref plus a clamp threshold voltage and the voltage at node 110 minus a clamp threshold voltage.

The voltage V₁₁₂ at node 112 going high turns on level shift switch 128, such that current from node Vref causes level shift capacitor 125 to increase the voltage V₁₁₄ at node 114 to go high such that switches 124 and 122 become conductive. Switch 124 becoming conductive causes the voltage V₁₁₆ at node 116 to go low, such that switch 121 becomes nonconductive. In response to switch 121 being nonconductive and switch 122 being conductive, switch 122 causes the voltage V₁₁₈ at node 118 to become low, causing switch 196 to become nonconductive.

The voltage V₁₃₂ at node 132 going low turns off level shift switch 148, such that level shift resistor 147 conducts current from node 134 and causes the voltage V₁₃₄ at node 134 to go low such that switches 144 and 142 become nonconductive. Switch 144 becoming nonconductive allows current from node Vref through diodes 157 and 159 to cause the voltage V₁₃₆ at node 136 to go high. The voltage V₁₃₆ at node 136 being high turns on switch 141. In response to switch 141 being conductive and switch 142 being nonconductive, current from node Vref through switch 141 causes the voltage V₁₃₈ at node 138 to become high, causing switch 198 to become conductive. Clamp 126 clamps the voltage V₁₁₈ of node 118 to the voltage V₁₂₀ at node 120 minus a clamp threshold voltage. Clamp 146 clamps the voltage V₁₃₈ of node 138 to the voltage V₁₃₀ at node 130 minus a clamp threshold voltage.

As understood by those of skill in the art, the voltage at the node 110 has a maximum value equal to the lesser of: 1) the maximum values of the voltages at nodes 120 and 130, and 2) one threshold voltage (of switches 196 and 198) less than the high voltages V₁₁₈ and V₁₃₈ at nodes 118 and 138. In addition, as understood by those of skill in the art, the high voltages V₁₁₈ and V₁₃₈ at nodes 118 and 138 are equal to the reference voltage minus threshold voltages of diodes 153 and 157, diodes 155 and 159, and switches 121 and 141. Accordingly, in embodiments where all threshold voltages are the same, the voltage at the node 110 has a maximum value equal to the lesser of: 1) the maximum values of the voltages at nodes 120 and 130, and 2) four threshold voltages less than the reference voltage.

In some embodiments, the reference voltage is set to be at least four threshold voltages greater than the maximum values of the voltages at nodes 120 and 130, such that the voltage at the node 120 has a maximum value equal to the maximum values of the voltages at nodes 120 and 130.

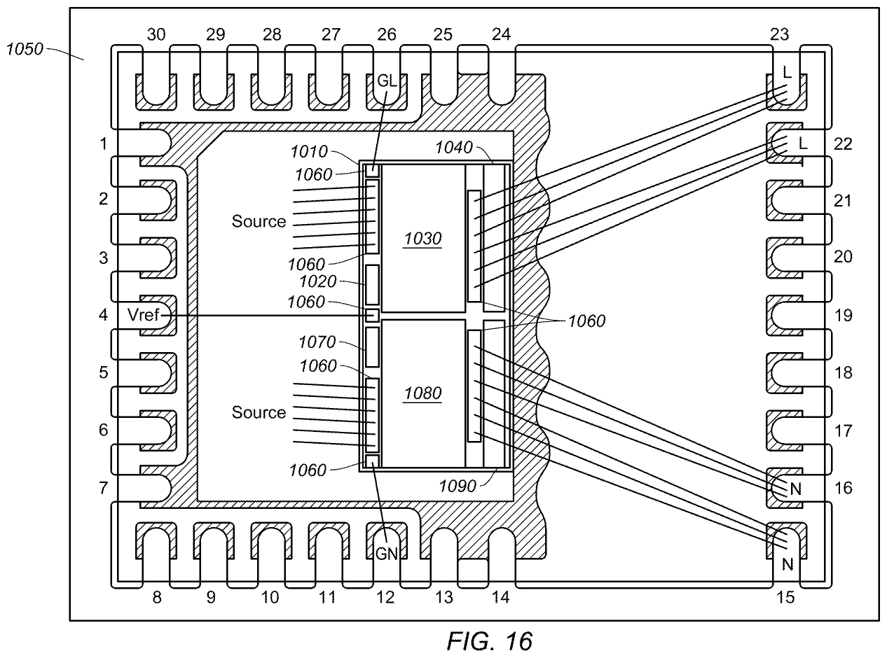

FIG. 16 is a schematic illustration of a packaging arrangement of a rectifier circuit. For example, physical implementations of any of the rectifier circuits discussed herein may have features illustrated in FIG. 16. Bond wire connections from bond wire pads 1060 on die 1010 to leads of lead frame 1050 are indicated. Bond wire connections from common source nodes to source package connections Source are also indicated. Bond wire connections from bond wire pads 1060 on die 1010 to node 118 (GL), node 138 (GN), node Vref, node 120 (L) and node 130 (N) leads of lead frame 1050 are also indicated.

In the illustrated embodiment, die 1010 includes a physical implementation of the receiver circuit of FIG. 12. In the illustrated embodiment, capacitor 151 is formed in area 1040, capacitor 161 is formed in area 1090, shorting switch 192 is formed in area 1030, shorting switch 194 is formed in area 1080, and the other elements of the switch control circuit are formed in areas 1020 and 1070.

In some embodiments all control, driver and shorting switch elements can be formed on a monolithic GaN-based semiconductor die. In further embodiments, one or more bridge diodes can be formed from silicon and co-packaged in an electronic package with the monolithic GaN-based die.

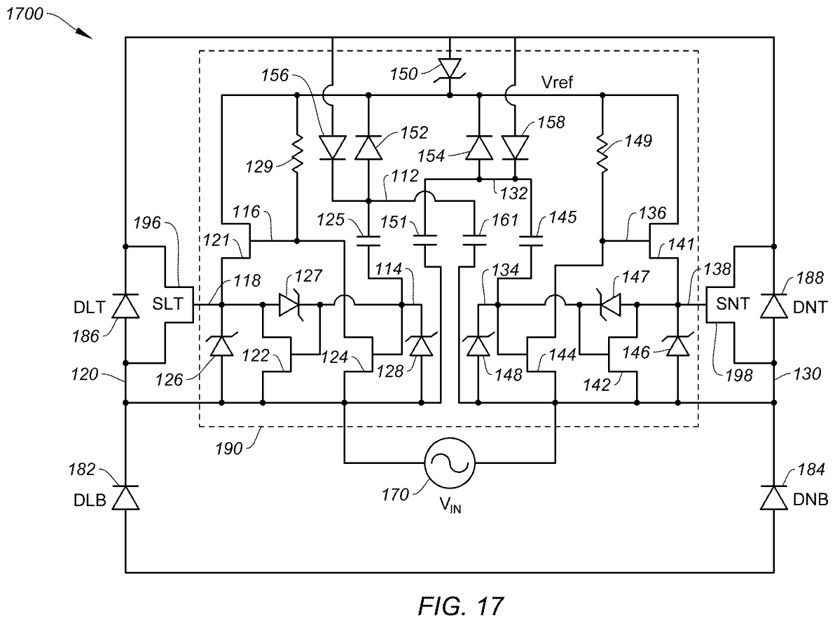

FIG. 17 is a schematic illustration of a rectifier circuit 1700, which is an embodiment of the rectifier circuit 700 illustrated in FIG. 7 including a more detailed schematic of one embodiment of the switch control circuit 190. As shown in FIG. 17, the control and driver elements of one embodiment of switch control circuit 190 are shown. Switch control circuit 190 is also used in FIGS. 8, 9 and 10 with like numbers referring to like elements.

The switch control circuit 190 of FIG. 17 has power connections and signal input connections to the Vin Positive node 120 and Vin Negative node 130, such that it does not require any external voltage sources to operate.

The rectifier circuit 1700 includes diodes 182, 184, 186, and 188, and shorting switches 196 and 198. The switch control circuit 190 of FIG. 17 has power connections to the nodes 120 and 130, as illustrated. In addition, the switch control circuit 190 of FIG. 17 has signal input connections to the nodes 120 and 130.

The switch control circuit 190 of FIG. 17 includes pull up switches 121 and 141, pull down switches 122 and 142, off switches 124 and 144, level shift capacitors 125 and 145, level shift diodes 127 and 147, level shift clamps 128 and 148, voltage clamps 152, 154, 156, 158, 126, 146, and 150, resistors 129 and 149, and capacitors 151 and 161.

In some embodiments, switches 121, 141, 196, and 198 have higher breakdown voltages than breakdown voltages of, for example, one or more of switches 124, 144, 122, and 142. For example, in some embodiments, switches 121, 141, 196, and 198 can tolerate drain to source, gate to drain, and gate to source voltages up to about 650 V. In some embodiments, switches 124, 144, 122, and 142 can tolerate drain to source, gate to drain, and gate to source voltages up to about 6.5 V.

The switch control circuit 190 of FIG. 17 includes an input coupling portion, comprising input capacitors 151 and 161. The switch control circuit 190 of FIG. 17 also includes first and second driver portions. The first driver portion comprises pull up switch 121, pull down switch 122, off switch 124, level shift diode 127, level shift capacitor 125, and level shift clamp 128. The second driver portion comprises pull up switch 141, pull down switch 142, off switch 144, level shift diode 147, level shift capacitor 145, and level shift clamp 148.

The first driver portion receives first input signals from capacitor 161 of the input coupling portion, and receives a power input from the node 120. Based on the first input signals, the first driver portion selectively causes the shorting switch 196 to be selectively conductive using current conducted from the voltage reference input node Vref by pull up switch 121 and current conducted to the power input from the node 120.

The second driver portion receives second input signals from capacitor 151 of the input coupling portion, and receives a power input from the node 130. Based on the second input signals, the second driver portion selectively causes the shorting switch 198 to be selectively conductive using current conducted from the voltage reference input node Vref by pull up switch 141 and current conducted to the power input from the node 130.

The waveforms of FIG. 15 also show the operation of the rectifier circuit 1700 of FIG. 17, according to embodiments of the disclosure. In response to the input voltage across nodes 120 and 130 causing the voltage V₁₂₀ at node 120 to go high and the voltage V₁₃₀ at node 130 to go low, the signal input connection at input capacitor 151 causes the voltage V₁₃₂ at node 132 to go high, and the signal input connection at input capacitor 161 causes the voltage V₁₁₂ at node 112 to go low. Clamps 152, 154, 156, and 158 respectively clamp the high and low voltages of nodes 112 and 132 to the reference voltage at input node Vref plus a clamp threshold voltage and the voltage at node 110 minus a clamp threshold voltage.

In some embodiments the reference voltage may be generated by an integrated reference voltage source formed on the same monolithic die as the other driver and control components or can be generated externally, for example, using a reference generator. The reference voltage may be generated externally, for example, using a reference generator, for example, including a Zener reference diode 150.

In some embodiments, the reference voltage at input node Vref is generated based on a current. In some embodiments, the current is provided to the reference generator by an external current source. In some embodiments, the current is provided to the reference generator by clamps 152 and 154.

The voltage V₁₁₂ at node 112 going low causes level shift capacitor 125 to reduce the voltage V₁₁₄ at node 114 to go low such that switches 124 and 122 become nonconductive. Switch 124 becoming nonconductive allows current from resistor 129 to cause the voltage V₁₁₆ at node 116 to go high. The voltage V₁₁₆ at node 116 being high turns on switch 121.

In response to switch 121 being conductive and switch 122 being nonconductive, current from node Vref through switch 121 causes the voltage V₁₁₈ at node 118 to become high, causing switch 196 to become conductive.

The voltage V₁₃₂ at node 132 going high causes level shift capacitor 145 to increase the voltage V₁₃₄ at node 134 to go high such that switches 144 and 142 become conductive. Switch 144 becoming conductive causes the voltage V₁₃₆ at node 136 to go low, such that switch 141 becomes nonconductive. In response to switch 141 being nonconductive and switch 142 being conductive, switch 142 causes the voltage V₁₃₈ at node 138 to become low, causing switch 198 to become nonconductive.

In response to the input voltage across nodes 120 and 130 causing the voltage V₁₂₀ at node 120 to go low and the voltage V₁₃₀ at node 130 to go high, the signal input connection at input capacitor 151 causes the voltage V₁₃₂ at node 132 to go low, and the signal input connection at input capacitor 161 causes the voltage V₁₁₂ at node 112 to go high. Clamps 152, 154, 156, and 158 respectively clamp the high and low voltages of nodes 112 and 132 to the reference voltage at input node Vref plus a clamp threshold voltage and the voltage at node 110 minus a clamp threshold voltage.

The voltage V₁₁₂ at node 112 going high causes level shift capacitor 125 to increase the voltage V₁₁₄ at node 114 to go high such that switches 124 and 122 become conductive. Switch 124 becoming conductive causes the voltage V₁₁₆ at node 116 to go low, such that switch 121 becomes nonconductive. In response to switch 121 being nonconductive and switch 122 being conductive, switch 122 causes the voltage V₁₁₈ at node 118 to become low, causing switch 196 to become nonconductive.

The voltage V₁₃₂ at node 132 going low causes level shift capacitor 145 to decrease the voltage V₁₃₄ at node 134 to go low such that switches 144 and 142 become nonconductive. Switch 144 becoming nonconductive allows current from resistor 149 to cause the voltage V₁₃₆ at node 136 to go high. The voltage V₁₃₆ at node 136 being high turns on switch 141. In response to switch 141 being conductive and switch 142 being nonconductive, current from node Vref through switch 141 causes the voltage V₁₃₈ at node 138 to become high, causing switch 198 to become conductive.

Clamp 126 clamps the voltage V₁₁₈ of node 118 to the voltage V₁₂₀ at node 120 minus a clamp threshold voltage. Clamp 146 clamps the voltage V₁₃₈ of node 138 to the voltage V₁₃₀ at node 130 minus a clamp threshold voltage.

As understood by those of skill in the art, the voltage at the node 110 has a maximum value equal to the lesser of: 1) the maximum values of the voltages at nodes 120 and 130, and 2) one threshold voltage (of switches 196 and 198) less than the high voltages V₁₁₈ and V₁₃₈ at nodes 118 and 138. In addition, as understood by those of skill in the art, the high voltages V₁₁₈ and V₁₃₈ at nodes 118 and 138 are equal to the reference voltage minus threshold voltages of diodes 153 and 157, diodes 155 and 159, and switches 121 and 141. Accordingly, in embodiments where all threshold voltages are the same, the voltage at the node 110 has a maximum value equal to the lesser of: 1) the maximum values of the voltages at nodes 120 and 130, and 2) four threshold voltages less than the reference voltage.

In some embodiments, the reference voltage is set to be at least four threshold voltages greater than the maximum values of the voltages at nodes 120 and 130, such that the voltage at the node 120 has a maximum value equal to the maximum values of the voltages at nodes 120 and 130.

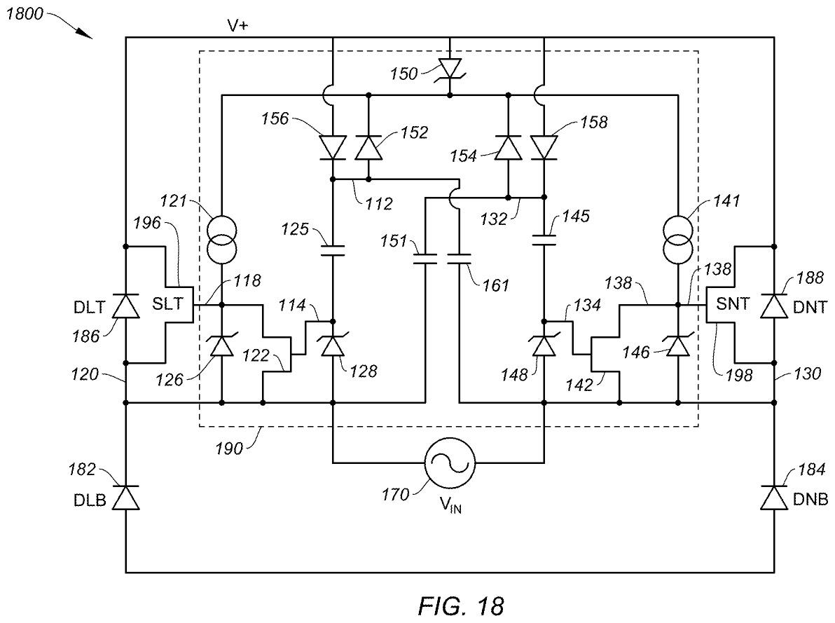

FIG. 18 is a schematic illustration of a rectifier circuit 1800, which is an embodiment of the rectifier circuit 700 illustrated in FIG. 7 including a more detailed schematic of one embodiment of the switch control circuit 190. As shown in FIG. 18, the control and driver elements of one embodiment of switch control circuit 190 are shown. Switch control circuit 190 is also used in FIGS. 8, 9 and 10 with like numbers referring to like elements.

The switch control circuit 190 of FIG. 18 has power connections and signal input connections to the Vin Positive node 120 and Vin Negative node 130, such that it does not require any external voltage sources to operate.

The rectifier circuit 1800 includes diodes 182, 184, 186, and 188, and shorting switches 196 and 198. The switch control circuit 190 of FIG. 18 has power connections to the nodes 120 and 130, as illustrated. In addition, the switch control circuit 190 of FIG. 18 has signal input connections to the nodes 120 and 130.

The switch control circuit 190 of FIG. 18 includes current sources 121 and 141, pull down switches 122 and 142, level shift capacitors 125 and 145, level shift clamps 128 and 148, voltage clamps 152, 154, 156, 158, 126, 146, and 150, and capacitors 151 and 161.

In some embodiments, switches 196 and 198 have higher breakdown voltages than breakdown voltages of, for example, one or more of switches 122 and 142. For example, in some embodiments, switches 196 and 198 can tolerate drain to source, gate to drain, and gate to source voltages up to about 650 V. In some embodiments, switches 122 and 142 can tolerate drain to source, gate to drain, and gate to source voltages up to about 6.5 V.

The switch control circuit 190 of FIG. 18 includes an input coupling portion, comprising input capacitors 151 and 161. The switch control circuit 190 of FIG. 18 also includes first and second driver portions. The first driver portion comprises current source 121, pull down switch 122, level shift capacitor 125, and level shift clamp 128. The second driver portion comprises current source 141, pull down switch 142, level shift capacitor 145, and level shift clamp 148.

The first driver portion receives first input signals from capacitor 161 of the input coupling portion, and receives a power input from the node 120. Based on the first input signals, the first driver portion selectively causes the shorting switch 196 to be selectively conductive using current conducted from the voltage reference input node Vref by current source 121 and current conducted to the power input from the node 120.

The second driver portion receives second input signals from capacitor 151 of the input coupling portion, and receives a power input from the node 130. Based on the second input signals, the second driver portion selectively causes the shorting switch 198 to be selectively conductive using current conducted from the voltage reference input node Vref by current source 141 and current conducted to the power input from the node 130.

Current sources 121 and 141 may be formed using any circuit techniques known to those of skill in the art.

The waveforms of FIG. 15 also show the operation of the rectifier circuit 1800 of FIG. 18, according to embodiments of the disclosure. In response to the input voltage across nodes 120 and 130 causing the voltage V₁₂₀ at node 120 to go high and the voltage V₁₃₀ at node 130 to go low, the signal input connection at input capacitor 151 causes the voltage V₁₃₂ at node 132 to go high, and the signal input connection at input capacitor 161 causes the voltage V₁₁₂ at node 112 to go low. Clamps 152, 154, 156, and 158 respectively clamp the high and low voltages of nodes 112 and 132 to the reference voltage at input node Vref plus a clamp threshold voltage and the voltage at node 110 minus a clamp threshold voltage.

In some embodiments the reference voltage may be generated by an integrated reference voltage source formed on the same monolithic die as the other driver and control components or can be generated externally, for example, using a reference generator. The reference voltage may be generated externally, for example, using a reference generator, for example, including a Zener reference diode 150.

In some embodiments, the reference voltage at input node Vref is generated based on a current. In some embodiments, the current is provided to the reference generator by an external current source. In some embodiments, the current is provided to the reference generator by clamps 152 and 154.

The voltage V₁₁₂ at node 112 going low causes level shift capacitor 125 to reduce the voltage V₁₁₄ at node 114 to go low such that switch 122 becomes nonconductive. Switch 122 becoming nonconductive allows current from current source 121 to cause the voltage V₁₁₈ at node 118 to go high. The voltage V₁₁₈ at node 118 going high causes switch 196 to become conductive.

The voltage V₁₃₂ at node 132 going high causes level shift capacitor 145 to increase the voltage V₁₃₄ at node 134 to go high such that switch 142 becomes conductive. Switch 142 becoming conductive causes the voltage V₁₃₈ at node 138 to become low, causing switch 198 to become nonconductive.

In response to the input voltage across nodes 120 and 130 causing the voltage V₁₂₀ at node 120 to go low and the voltage V₁₃₀ at node 130 to go high, the signal input connection at input capacitor 151 causes the voltage V₁₃₂ at node 132 to go low, and the signal input connection at input capacitor 161 causes the voltage V₁₁₂ at node 112 to go high. Clamps 152, 154, 156, and 158 respectively clamp the high and low voltages of nodes 112 and 132 to the reference voltage at input node Vref plus a clamp threshold voltage and the voltage at node 110 minus a clamp threshold voltage.

The voltage V₁₁₂ at node 112 going high causes level shift capacitor 125 to increase the voltage V₁₁₄ at node 114 to go high such that switch 122 becomes conductive. Switch 122 becoming conductive causes the voltage V₁₁₈ at node 118 to become low, causing switch 196 to become nonconductive.

The voltage V₁₃₂ at node 132 going low causes level shift capacitor 145 to decrease the voltage V₁₃₄ at node 134 to go low such that switch 142 becomes nonconductive. Switch 142 becoming nonconductive allows current from current source 141 to cause the voltage V₁₃₈ at node 138 to become high, causing switch 198 to become conductive.

Clamp 126 clamps the voltage V₁₁₈ of node 118 to the voltage V₁₂₀ at node 120 minus a clamp threshold voltage. Clamp 146 clamps the voltage V₁₃₈ of node 138 to the voltage V₁₃₀ at node 130 minus a clamp threshold voltage.

As understood by those of skill in the art, the voltage at the node 110 has a maximum value equal to the lesser of: 1) the maximum values of the voltages at nodes 120 and 130, and 2) one threshold voltage (of switches 196 and 198) less than the high voltages V₁₁₈ and V₁₃₈ at nodes 118 and 138. In addition, as understood by those of skill in the art, the high voltages V₁₁₈ and V₁₃₈ at nodes 118 and 138 are equal to the reference voltage minus threshold voltages of diodes 153 and 157, diodes 155 and 159, and switches 121 and 141. Accordingly, in embodiments where all threshold voltages are the same, the voltage at the node 110 has a maximum value equal to the lesser of: 1) the maximum values of the voltages at nodes 120 and 130, and 2) four threshold voltages less than the reference voltage.

In some embodiments, the reference voltage is set to be at least four threshold voltages greater than the maximum values of the voltages at nodes 120 and 130, such that the voltage at the node 120 has a maximum value equal to the maximum values of the voltages at nodes 120 and 130.

Any of the diodes discussed herein may, for example, be pn junction diodes, Schottky diodes, Zener diodes, or another diode type, as understood by those of skill in the art. Any of the diodes discussed herein may, for example, be serially connected diodes so as to effectively form a diode having about two or more times the threshold voltage of a single diode. One or more of the diodes may be formed on the same semiconductor substrate as one or more other elements of the control circuitry discussed herein. In some embodiments, One or more of the diodes may be formed on separate semiconductor substrates as one or more other elements of the control circuitry discussed herein, where the substrate of the one or more diodes are co-packaged with one or more substrates of the one or more other elements. In some embodiments, one or more diodes are formed on separate semiconductor substrates as one or more other elements of the control circuitry discussed herein, are packaged separately from a package of the one or more other elements of the control circuitry, and are placed in or on a same board as the package of the one or more other elements of the control circuitry.

Though the present invention is disclosed by way of specific embodiments as described above, those embodiments are not intended to limit the present invention. Based on the methods and the technical aspects disclosed herein, variations and changes may be made to the presented embodiments by those of skill in the art without departing from the spirit and the scope of the present invention.

What is claimed is:

1. A circuit, comprising:
first, second third and fourth diodes connected to form a bridge rectification circuit having a pair of input terminals to receive an AC input signal and a pair of output terminals to deliver a rectified DC signal;
a first semiconductor switch coupled in parallel with the first diode;
a second semiconductor switch coupled in parallel with the second diode; and
a switch control circuit coupled to the pair of input terminals and arranged to selectively operate the first and second semiconductor switches using power from the AC input signal at the pair of input terminals.

2. The circuit of claim 1 wherein the first and second semiconductor switches are GaN-based transistors formed on a monolithic semiconductor die.

3. The circuit of claim 2 wherein the monolithic semiconductor die further includes a GaN-based first semiconductor switch driver circuit and a GaN-based second semiconductor switch driver circuit.

4. The circuit of claim 1 wherein:
one or more of the first, second, third, and fourth diodes, the first and second semiconductor switches, and at least a portion of the switch control circuit are formed on a first semiconductor substrate,
one or more of the first, second, third, and fourth diodes, the first and second semiconductor switches, and at least a portion of the switch control circuit are formed on a second semiconductor substrate, and
the first and second substrates are co-packaged in an electronic package.

5. The circuit of claim 1 wherein the switch control circuit controls the second semiconductor switch to become conductive during a time when a first forward bias voltage is applied across the second diode, and wherein the switch control circuit controls the first semiconductor switch to become conductive during a time when a second forward bias voltage is applied across the first diode.

6. An electronic device comprising:
a monolithic GaN-based semiconductor substrate comprising:
a first semiconductor switch having a first pair of terminals arranged to be electrically coupled in parallel with a first external diode;
a second semiconductor switch having a second pair of terminals arranged to be electrically coupled in parallel with a second external diode; and
a switch control circuit coupled to at least one terminal of the first pair of terminals and coupled to at least one terminal of the second pair of terminals, the switch control circuit arranged to selectively operate the first and second semiconductor switches using power from the at least one terminal of the first pair of terminals and the at least one terminal of the second pair of terminals.

7. The electronic device of claim 6 wherein the first pair of terminals includes a first input terminal configured to be coupled to an AC input signal and a first output terminal configured to be coupled to an output node of a diode bridge, and wherein the second pair of terminals includes a second input terminal configured to be coupled to the AC input signal and a second output terminal configured to be coupled to the output node of the diode bridge.

8. The electronic device of claim 6 wherein the switch control circuit controls the first semiconductor switch to become conductive during a time when a first forward bias voltage is applied across the first external diode, and wherein the switch control circuit controls the second semiconductor switch to become conductive during a time when a second forward bias voltage is applied across the second external diode.

9. The electronic device of claim 6 wherein:
one or more of the first and second semiconductor switches, and at least a portion of the switch control circuit are formed on a first semiconductor substrate,
one or more of the first and second semiconductor switches, and at least a portion of the switch control circuit are formed on a second semiconductor substrate, and
the first and second substrates are co-packaged in an electronic package.

10. The electronic device of claim 6 further comprising an electronic package formed around the monolithic GaN-based semiconductor substrate, the electronic package further formed around the first external diode and the second external diode.

11. A rectifier circuit, comprising:
first and second input nodes configured to collectively receive an AC voltage;
a ground node;
an output node;
first, second, third, and fourth conductive elements configured to provide a rectified voltage difference across the output node and the ground node based on the AC voltage input; and
a switch control circuit configured to generate a plurality of switch signals, wherein the switch control circuit comprises first and second power inputs respectively connected to the first and second input nodes, and wherein the AC voltage across the first and second input nodes causes the switch control circuit to generate the switch signals,
wherein the first conductive element comprises a first switch, configured to selectively conduct in response to a first switch signal from the switch control circuit, and
wherein the second conductive element comprises a second switch, configured to selectively conduct in response to a second switch signal from the switch control circuit.

12. The rectifier circuit of claim 11, wherein the first conductive element comprises a first diode in parallel with the first switch, and wherein the second conductive element comprises a second diode in parallel with the second switch.

13. The rectifier circuit of claim 11, wherein there is no diode in parallel with any of the first and second switches.

14. The rectifier circuit of claim 11, wherein the switch control circuit comprises a coupling portion configured to generate input signals, wherein the switch control circuit is configured to generate the switch signals in response to the input signals.

15. The rectifier circuit of claim 14, wherein the switch control circuit comprises first and second driver portions configured to receive the input signals and to generate the switch signals in response to the input signals.

16. The rectifier circuit of claim 15, wherein the coupling portion is configured to receive the AC voltage across the first and second input nodes, and to generate the input signals by capacitively coupling the AC voltage to the first and second driver portions.

17. The rectifier circuit of claim 14, further comprising first and second clamps configured to clamp the input signals to a voltage based on a reference voltage.

18. The rectifier circuit of claim 17, further comprising third and fourth clamps configured to clamp the input signals to a DC or substantially DC voltage.

19. The rectifier circuit of claim 11, wherein the switch signals have voltages about equal to a reference voltage, whereby the switches receiving the switch signals are caused to become conductive.

20. The rectifier circuit of claim 11, wherein the switch signals have voltages greater than the maximum voltages of the first and second input nodes, whereby the switches receiving the switch signals are caused to become conductive.

21. The rectifier circuit of claim 11, wherein the switch signals have voltages less than the maximum voltages of the first and second input nodes, whereby the switches receiving the switch signals are caused to become conductive.

22. A switch circuit, comprising:
a semiconductor substrate, comprising GaN;
first and second input nodes formed on the substrate;
a switch control circuit formed on the substrate, wherein the switch control circuit comprises first and second power inputs respectively connected to the first and second input nodes, and wherein the switch control circuit is configured to generate a plurality of switch signals in response to an AC voltage across the first and second input nodes; and
a first switch formed on the substrate, wherein the first switch is connected to the first input node, and wherein the first switch is configured to selectively conduct in response to a first switch signal from the switch control circuit.

23. The switch circuit of claim 22, further comprising a second switch formed on the substrate, wherein the second switch is connected to the second input node, and wherein the second switch is configured to selectively conduct in response to a first switch signal from the switch control circuit.

24. The switch circuit of claim 22, further comprising first and second diodes, wherein the first diode is connected in parallel with the first switch, and wherein the second diode is connected in parallel with the second switch.

25. The switch circuit of claim 24, wherein the first and second diodes are packaged with the substrate in an electronic package.

26. The switch circuit of claim 24, further comprising third and fourth diodes, wherein the third diode is connected to the first switch and to the first diode, and wherein the second diode is connected to the second switch and to the second diode.

27. The switch circuit of claim 26, wherein the first, second, third, and fourth diodes are packaged with the substrate in an electronic package.

28. The switch circuit of claim 22, wherein the switch control circuit comprises:
a coupling portion configured to generate input signals, wherein the switch control circuit is configured to generate the switch signals in response to the input signals; and
first and second driver portions configured to receive the input signals and to generate the switch signals in response to the input signals.

29. The switch circuit of claim 28, wherein the coupling portion is configured to receive the AC voltage across the first and second input nodes, and to generate the input signals by capacitively coupling the AC voltage to the driver portions.

30. The switch circuit of claim 28, further comprising:
first and second clamps formed on the substrate, wherein the first and second clamps are configured to clamp the input signals to a voltage based on a reference voltage; and
third and fourth clamps formed on the substrate, wherein the third and fourth clamps are configured to clamp the input signals to a DC or substantially DC voltage.
